(19) United States
(12) Patent Application Publication
(10) Pub. No.: US 2024/0131480 A1
(43) Pub. Date: Apr. 25, 2024

(54) APPARATUS FOR CARBONATING A LIQUID IN A BOTTLE

(71) Applicant: mittemitte GmbH, Berlin (DE)

(72) Inventor: Chenming HA, Berlin (DE)

(73) Assignee: mittemitte GmbH, Berlin (DE)

(21) Appl. No.: 18/049,294

(22) Filed: Oct. 24, 2022

(51) Int. Cl. B01F 23/2361; B01F 23/236

(52) U.S. Cl. CPC B01F 23/2361; B01F 23/2364

(57) ABSTRACT

Described herein is an apparatus for carbonating a liquid in a bottle, said apparatus comprising a main body and a head, wherein said head is configured to hold a bottle filled with a liquid and wherein said head is movably attached to said main body such that said head with said bottle can be moved between a first position at said main body and a second position away from said main body through a threshold position between said first and said second position or at said second position, characterized in that said apparatus further comprises a switch and a valve operatively connected to said switch, wherein arranging said head with said bottle at said first position or between said first position and said threshold position causes said switch to close said valve or to keep said valve closed and wherein arranging said head with said bottle at said second position or between said second position and said threshold position causes said switch to open said valve or to keep said valve open.

### FIELD

The present invention relates to an apparatus for carbonating a liquid in a bottle.

### BACKGROUND

Carbonation apparatuses designed to turn still water in a bottle into sparkling water operate by injecting high pressure CO2 in the bottle, while the bottle is connected to the apparatus. Such bottles are typically mounted onto the apparatus at their openings, said opening having connecting means such as a thread, pins, or a collar. The connecting means of the bottle cooperate with securing means provided in the apparatus to create a gas-tight and rigid coupling. The bottle is typically held in a vertical orientation during carbonation. To limit the height of the apparatus, the head or the bottle on the head is typically pivotably attached to the apparatus, wherein the carbonation may be performed in the vertical orientation and the bottle may be removed from the apparatus after carbonation in a pivoted position with respect to the vertical orientation. However, upon carbonation, a force directed away from the apparatus and, in the pivoted position, possibly towards the user operating the apparatus is acting on the bottle. For this reason, carbonation devices typically comprise a release mechanism to release the residual pressure in the bottle once the carbonation process is done. Otherwise, either the user would not be able to remove the bottle from the device due to the force maintaining the coupling, or, if the user manages to loosen the coupling, the bottle is ejected under the pressure, causing a safety risk to the user.

In the prior art, the release mechanism has been for example realized as a passive mechanical valve which opens upon swiveling, as disclosed in U.S. Ser. No. 10/058,826B1. This method is advantageous in that it ensures the bottle is depressurized once a certain angle has been reached during swiveling, and makes it safe to remove the bottle. However, with this arrangement, the user decides when to remove the bottle. As such, the user might remove the bottle before excess CO2 gas above the liquid surface has time to dissolve into the water so as to reach an equilibrium state, which is known as the lull time. In this situation, the water might be carbonated to a level lower than desired, and CO2 is wasted. Moreover, passive mechanical valves typically operate in a sudden release of the gas triggering outgassing of the dissolved CO2, which in turn generates more nucleation sites for CO2 bubbles within the water, causing a release of more CO2 and possibly an unwanted spilling of water out of the bottle. Based on this, it is subject of the present invention to provide an apparatus for carbonating liquid in a bottle which allows for a safe and reliable release of gas from the bottle upon carbonation of the liquid.

### SUMMARY

This task is solved by an apparatus with the features of claim 1. Advantageous embodiments of the invention are given in the corresponding subclaims and described in the following.

The invention relates to an apparatus for carbonating a liquid in a bottle. The apparatus comprises a main body and a head, wherein said head is configured to hold a bottle filled with a liquid and wherein said head is movably attached to said main body such that said head with said bottle can be moved between a first position at said main body and a second position away from said main body through a threshold position between said first and said second position or at said second position. The apparatus further comprises a switch and a valve operatively connected to said switch, wherein arranging said head with said bottle at said first position or between said first position and said threshold position causes said switch to close said valve or to keep said valve closed. Arranging said head with said bottle at said second position or between said second position and said threshold position causes said switch to open said valve or to keep said valve open.

In an embodiment, said liquid in said bottle can be carbonated if the valve is closed, and gas can be released from said bottle through the valve, if said valve is open.

According to an embodiment, said head is pivotably attached to said main body, such that said head with said bottle can be pivoted between said first and said second position.

In another embodiment, said switch is a lever switch arranged between said main body and said head, wherein arranging said head with said bottle between said first position and said threshold position actuates a lever of said lever switch, causing said lever switch to close said valve or to keep said valve closed, and wherein arranging said head with said bottle between said second position and said threshold position releases said lever, causing said lever switch to open said valve or to keep said valve open.

The switch is preferably fixed to either the main body or the head. If the switch is fixed to the main body, the lever of the switch may cooperate with the head, such that moving the head between the first and the second position causes the head to actuate the switch. If the switch is fixed to the head, the lever of the switch may cooperate with the main body, such that moving the head between the first and the second position causes the main body to actuate the switch.

In an embodiment, the valve is a normally open valve.

According to an embodiment, said valve is a normally open solenoid valve, wherein actuating said lever enables said normally open solenoid valve to energize. By energizing said normally open solenoid valve, the normally open valve is closed or kept closed. In turn, according to this embodiment, releasing said lever causes said normally open solenoid valve to deenergize. By deenergizing said normally open solenoid valve, the normally open solenoid valve is opened or kept open.

Particularly, according to another embodiment, said normally open solenoid valve is configured to be energized by actuating the lever only upon a user input. As such, before using the apparatus to carbonate liquid in a bottle, the user may for example push a button, wherein the normally open solenoid valve is connected to a power supply, such that the normally open solenoid valve may be energized and thus closed for the carbonation process. Upon the carbonation process, releasing the lever may then cause the normally open solenoid valve to deenergize and thus to open, wherein essentially no current flows through the solenoid.

In other words, in the absence of a user input and/or between uses, the normally open solenoid valve may be disconnected from the power supply, such that it remains deenergized and thus open between uses, i.e. when no bottle is connected to the head. In particular, without the user input and if no bottle is mounted on the head, the normally open solenoid valve may remain open independently of the position of the head, that is, even if the head is arranged at the first position or between the first position and the threshold position. To this end, the apparatus, particularly the head may be equipped with a sensor configured to detect whether a bottle is mounted to the head or not. For example, the sensor is a weight sensor or an optical sensor.

Alternatively to the normally open valve, said valve comprises or is a normally closed solenoid valve. As such, releasing said lever may cause said normally closed solenoid valve to energize, which causes said normally closed solenoid valve to open or to keep said normally closed solenoid valve open and actuating said lever may cause said normally closed solenoid valve to deenergize, which causes said normally closed solenoid valve to close or to keep said normally closed solenoid valve closed.

In an embodiment, said first position and said threshold position are separated by a pivot angle of 2° to 15°.

Alternatively, the first head or the bottle mounted on the head may be moved between the first position and the second position by means of a translational movement. To this end, the head can be movably attached to the main body by means of guide rails or other means allowing for a translational movement.

Particularly, the first head or the bottle mounted on the head may be moved between the first position and the second position by means of a movement comprising both a translation and a pivoting.

According to another embodiment, said switch is an optical or gyroscopic switch configured to detect a position of said head with said bottle, and wherein if said optical or gyroscopic switch detects a position of said head with said bottle corresponding to a position at said first position or between said first and said threshold position, said switch causes said valve to close or to keep said valve closed and wherein if said optical or gyroscopic switch detects a position of said head with said bottle corresponding to a position between said second and said threshold position or at said second position, said optical or gyroscopic switch causes said valve to open or to keep said valve open.

Particularly, the optical switch may comprise a light source and a light detector. For example, the light source may be arranged in or on the main body or the head wherein the light source is configured to generate and emit light toward at least a section of the head or at least a section of the main body. The detector may likewise be arranged in or on the main body or the head and is configured to detect light emitted from the light source, particularly light of the light source reflected from the head or the main body. As such, the optical switch is configured to detect a position change between the head and the main body by means of a change of a measured reflection signal detected by the detector. Particularly, the first position may correspond to a first value of the reflection signal and the second position may correspond to a second value of the reflection signal, wherein one signal is larger than the other. The threshold position between the first and the second position may thus correspond to a third value of the reflection signal. Once the reflection signal reaches the third value, the optical switch may cause the valve to open or to close.

The gyroscopic switch is preferably used in combination with a pivotable head and arranged in or on the head, such that pivoting the head with respect to the main body causes a change in the gyroscopic resistance. Particularly, the first position may correspond to a first value of the gyroscopic resistance and the second position may correspond to a second value of the gyroscopic resistance, wherein one signal is larger than the other. The threshold position between the first and the second position may thus correspond to a third value of the gyroscopic resistance. Once the gyroscopic resistance reaches the third value, the gyroscopic switch may cause the valve to open or to close.

In yet another embodiment, the apparatus comprises a water tank configured to be filled with water, wherein said water tank is in fluidic connection with said bottle via a liquid line.

In an embodiment, the apparatus comprises a pump for pumping water from said water tank into said bottle.

According to another embodiment, the apparatus comprises a pressure relief valve in fluidic connection with said bottle via a pressure relief line, wherein said pressure relief valve is configured to open if a gas pressure inside said bottle exceeds a predetermined value, wherein gas is released from said bottle. For example, the predetermined value of the gas pressure is between 3 barA and 5 barA. ‘barA’ denotes an absolute pressure and not a pressure difference, particularly not the pressure difference between the inside the bottle and the outside of the bottle.

According to an embodiment, said pressure relief valve is operatively connected to said switch and wherein if said head with said bottle is arranged between said second and said threshold position or at said second position, said switch causes said pressure relief valve to open.

In an alternative embodiment, the valve according to the invention is configured to open if the gas pressure inside said bottle exceeds the predetermined value, wherein gas is released from said bottle. As such, the valve can be configured to open and close depending on the arrangement of the head relative to the main body according to the invention and to additionally act as a pressure relief valve.

In an embodiment, the apparatus comprises said bottle.

According to another embodiment, an opening portion of said bottle forms a male counterpart complementary to a female receptor portion of said head, such that said bottle and said head are configured and arranged to be connected to each other via a bayonet mount formed by said female receptor portion of said head and said opening portion of said bottle.

In an embodiment, the apparatus comprises a pressurizing line for carbonating said liquid in said bottle, a normally closed valve arranged along said pressurizing line, a trigger mechanism operatively connected to said normally closed valve, as well as a gas source fluidly connected to said pressurizing line, wherein actuating said trigger mechanism causes said normally closed valve to open, creating a fluid connection between said gas source and said bottle, wherein a predetermined amount of gas is injected from said gas source to said bottle. For example, the predetermined amount of gas is between 5 g and 20 g.

In another embodiment, the apparatus comprises a pressure reducer arranged or arrangeable between said gas source and said normally closed valve, said pressure reducer being configured to reduce an upstream pressure in said gas source to a predetermined downstream pressure in said pressurizing line between said pressure reducer and said normally closed valve. For example, the pressure reducer is configured to reduce the upstream pressure from a pressure of 56 barA to a downstream pressure of 5 to 10 barA.

According to another embodiment, the apparatus comprises said pump for pumping water from said water tank into said bottle, said normally closed valve arranged downstream of said gas source along said pressurizing line as well as a control unit operatively connected to said pump and said normally closed valve, wherein said control unit is configured to cause said pump to pump water from said water tank into said bottle and wherein said control unit is configured to cause said normally closed valve to open or to close, such that gas can be injected from said gas source into said bottle.

Preferably, the control unit comprises a processing unit and a power supply. The control unit, particularly the processing unit may be configured to send control signals to electrical components of the apparatus, such as for example the pump and/or the normally closed valve and/or the normally open solenoid valve so as to cause the pump to pump water or to stop pumping water and/or to cause the normally closed valve to open or to close and/or to cause the normally open solenoid valve to open or to close. To this end, the control unit, particularly the processing unit may be configured to establish or interrupt an electrical connection between the power supply and the pump and/or to establish or interrupt an electrical connection between the power supply and the normally closed valve and/or to establish or interrupt an electrical connection between the power supply and the normally open solenoid valve. The control unit, particularly the processing unit is preferably configured to send output signals to the electrical components and to receive input signals from the electrical components, so as to operate the electrical components and to determine an operational status of the respective component, wherein the operational status indicates for example if the pump is currently pumping or not.

In yet another embodiment, said switch is operatively connected to said control unit, such that if said switch is opening said valve or keeping said valve open, said control unit causes said pump not to pump water from said water tank into said bottle and said normally closed valve to close, such that no water or gas is injected into said bottle, and wherein the control unit generates an optical warning signal visible for a user on said apparatus.

According to an embodiment, said switch is operatively connected to said control unit, such that if said switch is closing said valve or keeping said valve closed, said control unit can cause said pump to pump water from said water tank into said bottle and said normally closed valve to open, such that water and gas can be injected into said bottle.

In another embodiment, the apparatus comprises a mechanism configured to open said valve upon carbonation of said liquid in said bottle after a predetermined lull time, such that gas can be released from said bottle through said valve. For example, the lull time is between 5 s and 20 s.

In yet another embodiment, said mechanism is configured to release said gas in a sequence of subsequent opening and closing events of said valve. For example, the sequence may comprise four opening events and three closing events. For example, a single opening event corresponds to an opening of the valve for 1 s and a single closing event corresponds to a closing of the valve for 1s.

According to an embodiment, the apparatus comprises a control unit with a safety shutdown function configured such that upon a failure event, said safety shutdown function stops fluid transfer into the bottle and causes said valve to open and said normally closed valve to close, such that gas may be released from said bottle. Particularly, the safety shutdown function is configured to stop the fluid transfer in case of a failure event related to the control unit, particularly the processing unit, such that if the control unit fails to send control signals, the safety shutdown function stops the fluid transfer. For example, the control unit, particularly the processing unit may be configured to send a specific signal to a transistor, wherein the transistor is configured to establish or to interrupt an electrical connection between the power supply and a respective electrical component of the apparatus. As long as the transistor receives said specific signal, it maintains the electrical connection between the power supply and the respective electrical component. In case of a failure of the control unit, particularly the processing unit, the signal is distorted or no longer received by the transistor, which effects an interruption of the electrical connection between the power supply and the respective electrical component. For example, the specific signal is a square signal alternating between an on value and an off value with a predetermined frequency. In case of a failure event, the specific signal may be distorted for example by remaining at the on or the off value, which causes the safety shutdown function to stop the fluid transfer.

In another embodiment, if said bottle is held by said head and if said head with said bottle is arranged between said first and said threshold position, and wherein upon an input signal of a user, said control unit causes said pump to pump a predetermined amount of water from said water tank into said bottle and causes said normally closed valve to open, wherein a predetermined amount gas is injected into said water in said bottle. For example, the predetermined amount of water is between 0.5 l and 1 l.

### BRIEF DESCRIPTION OF THE DRAWINGS

Exemplary embodiments are described below in conjunction with the Figures. The Figures are appended to the claims and are accompanied by text explaining individual features of the shown embodiments and aspects of the present invention. Each individual feature shown in the Figures and/or mentioned in the text of the Figures may be incorporated (also in an isolated fashion) into a claim relating to the apparatus according to the present invention.

FIG. 1 shows an example embodiment of the apparatus, wherein the head is arranged in the first position;

FIG. 2 shows the example embodiment of FIG. 1, wherein the head with a bottle mounted on the head are arranged in the second position;

FIG. 3 shows the switch arranged in a connecting portion between the head and the main body, wherein the head is arranged in the first position as in FIG. 1, causing the switch to close the valve;

FIG. 4 shows the switch in the connecting portion, wherein the head is arranged in the second position as in FIG. 2, causing the switch to open the valve; and

FIG. 5 shows a second example embodiment of the apparatus with a water tank for filling the bottle with water and a gas source for carbonating the water in the bottle.

### DETAILED DESCRIPTION

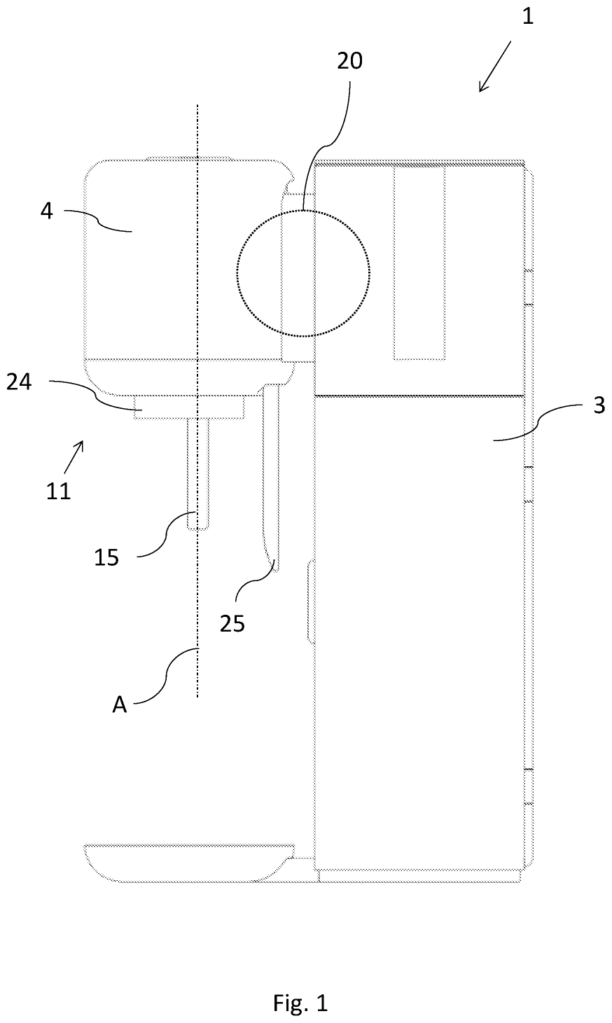

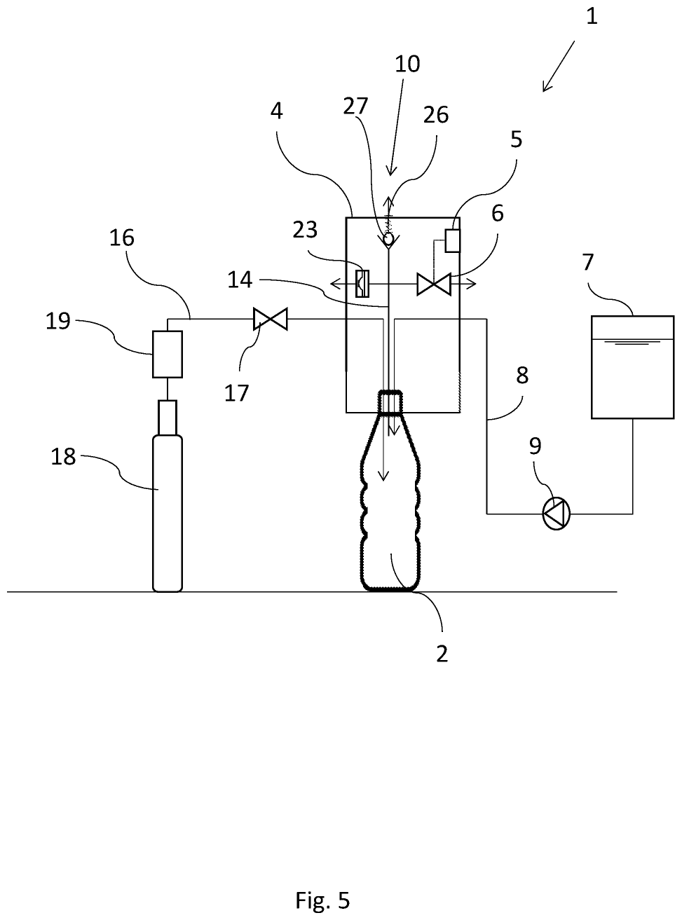

FIG. 1 shows a first example embodiment of the apparatus 1 for carbonating liquid in a bottle 2. The apparatus 1 comprises a main body 3 as well as a head 4 connected to the main body 3 via a connection portion 20. The main body 3 may comprise further components of the apparatus 1 such as for example a water tank 7, a pump 9 for pumping water from the water tank 7 into a bottle 2 mounted on the head 4 and a gas source 18, as further depicted in FIG. 5.

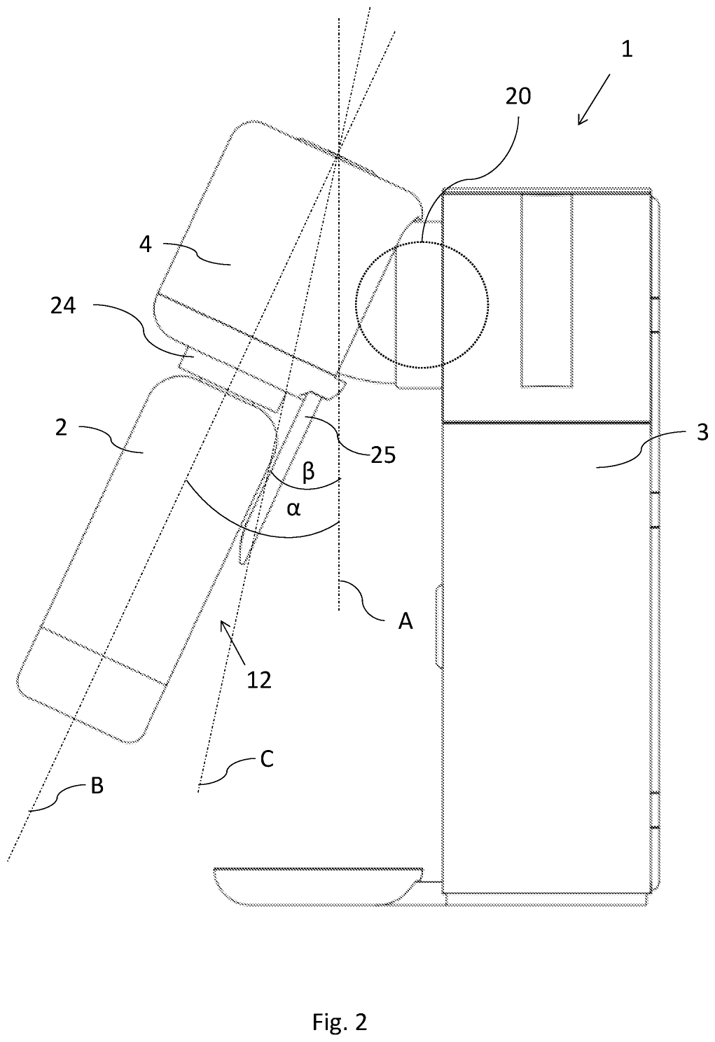

The head 4 comprises a female receptor portion 24 such that a bottle 2 can be mounted on the head 4 via the receptor portion 24 in a bayonet mount. The bottle 2 mounted on the head 4 is shown in FIG. 2. As can be seen here in FIG. 1, the head 4 further comprises a port 15 for conducting gas into the bottle 2 such that the liquid in the bottle 2 can be carbonated.

The head 4 is pivotably attached to the main body 3, wherein the head 4 is shown in a first position 11 at the main body 3 in FIG. 1, in which the head 4 is arranged along a vertical first axis A. In this first position 11, a switch 5 causes a valve 6 for releasing gas from the bottle 2 to close the valve 6 or to keep the valve 6 closed, such that liquid in the bottle 2 can be carbonated. In this example embodiment, the switch 5 is arranged in the connecting portion 20. As can further be seen in FIG. 1, the head 4 also comprises a handle 25 for manually tilting the bottle 2 held by the head 4 without exerting a force on the bottle 2 into the position depicted in FIG. 2.

In FIG. 2, the head 4, particularly the bottle 2 mounted on the head 4, is no longer oriented in the first position 11 at the main body 3 along the first axis A but is pivoted into a second position 12 away from the main body 3, such that a user can remove the bottle 2 from the apparatus 1 after carbonating the liquid. In this second position 12, the head 4 or the bottle 2 mounted on the head 4 is oriented along a second axis B, wherein the second axis B forms an angle α with said vertical first axis A. For example, the angle α is between 15° and 45°. A third axis C is indicated in FIG. 2 and marks a threshold position 13 of the head 4 or the bottle 2 mounted on the head 4. The third axis C forms an angle β of preferably 2° to 15°, particularly at an angle β of 2.1°, with the first axis A. According to the invention, arranging the head 4 or the bottle 2 mounted on the head 4 at the second position 12 or between the second position 12 and the threshold position 13 causes the switch 5 to open the valve 6 or the keep the valve 6 open, such that gas can be released from the bottle 2 through the valve 6. As such, the pivoting of the bottle 2 mounted to the head 4 away from the main body 3 effects an opening of the valve 6 via the switch 5, such that a pressure excess inside the bottle 2 relative to the pressure outside the bottle 2 caused by the carbonation of the liquid in the bottle 2 is released through the valve 6, which advantageously reduces the risk of an ejection of the bottle 2 towards a user operating the apparatus 1.

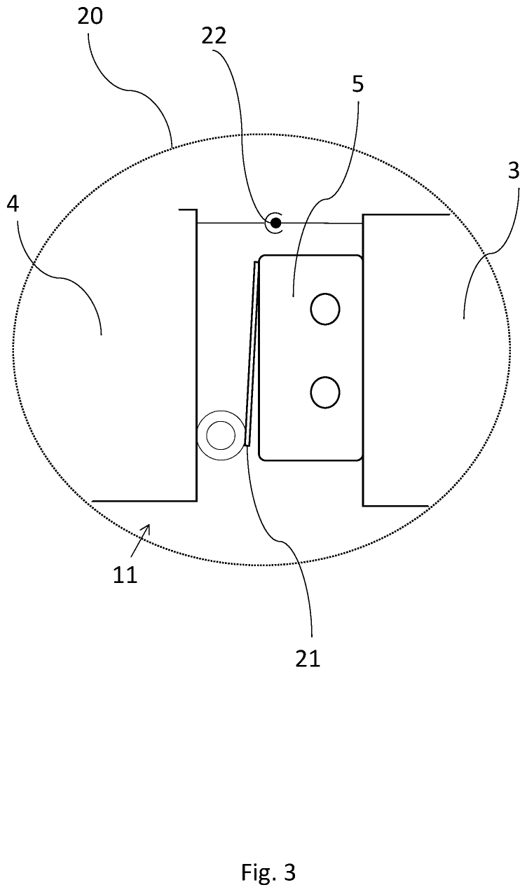

FIG. 3 highlights the switch 5 arranged in the connecting portion 20 between the main body 3 and the head 4 of the apparatus. In this example, the switch 5 is a lever switch with a flexible lever 21. The lever switch is prestressed, such that its lever 21 pushes against the head 4. The switch 5 is operatively connected to the valve 6 for releasing gas from the bottle 2, wherein the arrangement of the head 4 or the bottle 2 mounted on the head 4 relative to the main body 4 causes the switch 5 to open or close the valve 6.

In FIG. 3, the head 4 is arranged in the first position 11, keeping the lever 21 in an essentially vertical orientation corresponding to a first setting of the switch 5. In its first setting, the switch 5 closes the valve 6 or keeps it closed, such that gas can be injected into the bottle 2 to carbonate the liquid in the bottle 2. For example, the valve 6 is a normally open solenoid valve, wherein actuating the lever 21 as shown in FIG. 3 causes the switch 5 to keep the solenoid energized and thus the valve 6 closed.

As can be further seen in FIG. 3, a hinge 22 is arranged in the connection portion 20, wherein the hinge 22 forms a pivot axis for pivoting the head 4 or the bottle 2 mounted on the head 4 relative to the main body 3.

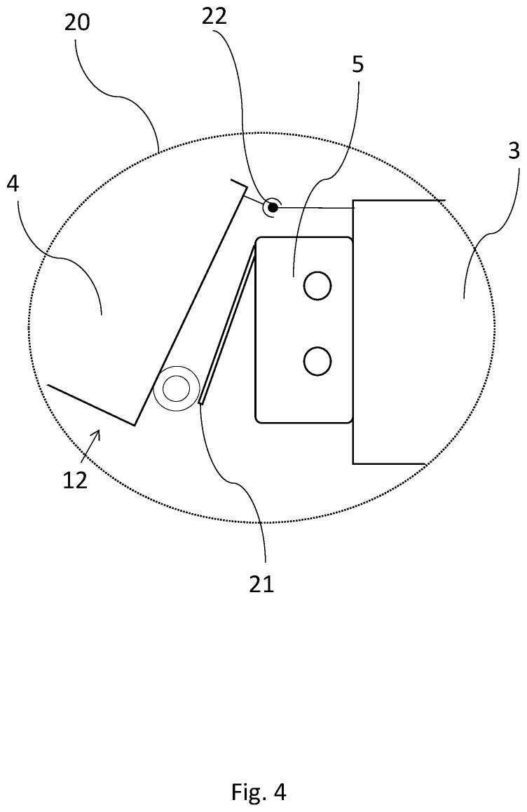

In FIG. 4, the switch 5 arranged in the connection portion 20 is shown with the head 4 or the bottle 2 mounted on the head 4 pivoted into the second position 12. The flexible lever 21 pushing against the head 4 is now pivoted away from the vertical orientation shown in FIG. 1. Particularly in this pivoted orientation of the lever 21, the switch 5 is now in a second setting, wherein the switch 5 opens the valve 6 or keeps it open, such that gas can be released from the bottle 2. In the example of the normally open solenoid valve, releasing the lever 21 as shown in FIG. 4 causes the switch 5 to deenergize the solenoid and thus to open the valve 6 or to keep it opened.

As such, pivoting the bottle 2 between the first and the second position 11,12 actuates the lever 21 of the switch 5, such that depending on the arrangement of the head 4 with respect to the main body 3, the valve 6 is opened or closed by the switch 5. In particular, the switch 5 switches from the first setting to the second setting or vice versa once the head 4 or the bottle 2 mounted on the head 4 is pivoted through the threshold position 13.

In an alternative embodiment, the valve 6 is a normally open solenoid valve which may only be energized and thus closed upon a user input, such as a user pressing a button, if a bottle 2 is mounted on the head 4, such that liquid in the bottle 2 can be carbonated. In turn, between two carbonation processes and without a user input, the normally open solenoid valve may remain open for all positions between the first and the second position 11,12, if no bottle 2 is mounted on the head 4.

FIG. 5 shows a second example embodiment of the apparatus 1 for carbonating liquid in a bottle 2.

According to this embodiment, the apparatus comprises a water tank 7 in fluidic connection with the inside of the bottle 2 via a liquid line 8. The apparatus 1 further comprises a pump 9 for pumping water from the water tank 7 into the bottle 2, which is in this example embodiment arranged between the water tank 7 and the bottle 2.

The apparatus shown in FIG. 5 further comprises a gas source 18 comprising pressurized carbon dioxide. The gas source 18 is or can be connected to a pressurizing line 16 forming a fluidic connection between the gas source 18 and the inside of the bottle 2, such that the water inside the bottle 2 can be carbonated via the pressurizing line 16. A normally closed valve 17 is arranged on the pressurizing line 16 between the bottle 2 and the gas source 18, thus preventing unwanted gas flow out of the gas source 18. The normally closed valve 17 can be opened by a trigger mechanism, wherein a predetermined amount of gas is injected from the gas source 18 into the bottle 2. Between the normally closed valve 17 and the gas source 18, a pressure reducer 19 is arranged on the pressurizing line 16 to reduce the pressure on the side of the gas source 18 down to a predetermined pressure on the side of the normally closed valve 17.

The water from the water tank 7 and the gas from the gas source 18 are conducted into the bottle 2 respectively via the liquid line 8 and the pressurizing line 16 through the head 4, which is indicated in FIG. 5. The head 4 further comprises a pressure relief line 14 for releasing gas from the bottle 2. In this embodiment, the pressure relief line 14 splits into three paths, such that three different mechanisms are provided for releasing gas from the bottle 2 to reduce the risk of a dangerous ejection of the bottle 2 mounted on the head 4 caused by overpressure inside the bottle 2.

A first path comprises the valve 6 operatively connected to the switch 5, which causes an opening of the valve 6 once the head 4 is pivoted into a position at the second position 12 or between the second position 12 and the threshold position 13, as indicated in FIGS. 1 to 4.

A second path comprises a pressure relief valve 10 realized by a spring 27 exerting a spring force directed on a blocking element 26, pushing the blocking element 26 towards an opening of the relief line 14 so as to close the second path. Once the pressure in the bottle 2 and thus the pressure relief line 14, particularly the second path, reaches a predetermined value, the blocking element 27 is pushed upwards such that gas may be released through the second path.

A third path comprises a burst disc 23 configured to burst, break or rupture at the predetermined value of overpressure so as to open the third path to the atmosphere. As such, the third path provides another security mechanism to release gas from the bottle 2 in case the valve 6 and/or the pressure relief valve 10 are not operational, for example in case of contaminations inside the first and the second path caused by sugar, which may lead to an unwanted fixation of the valves 6,10 such that they can no longer be opened.

For example, for the embodiment shown in FIG. 5, water may be carbonated by the apparatus as follows: upon a user input such as a start button being pressed, and the bottle 2 being connected to the head 4 of the apparatus in a vertical orientation, the pump 9 is instructed to fill the bottle 2 with a predetermined amount of water stored in the tank 7. During this step, said valve 6 is preferably closed. After the filling, a predetermined amount of gas is injected into the bottle 2 via the pressurizing line 16, wherein the gas is partially dissolved, and the pressure in the bottle 2 increases and the water is being carbonated. The pressure release valve 10 ensures the pressure within the bottle does not increase beyond said predetermined value by opening beyond said predetermined value. Once the injection of gas has ended, the apparatus is left in a waiting step with the valve 6 remaining closed for a predetermined amount of time, called lull time. Once the lull time has elapsed, said valve 6 is automatically opened in a sequence of subsequent opening and closing events such as to equalize the pressure within the bottle 2 with the pressure outside the bottle 2. After that step, the user is notified that the process has ended and the user can now pivot the head 4 of the apparatus and remove the bottle.

I claim:

1. An apparatus for carbonating a liquid in a bottle, said apparatus comprising a main body and a head, wherein said head is configured to hold a bottle filled with a liquid and wherein said head is movably attached to said main body such that said head with said bottle can be moved between a first position at said main body and a second position away from said main body through a threshold position between said first and said second position or at said second position, characterized in that said apparatus further comprises a switch and a valve operatively connected to said switch, wherein arranging said head with said bottle at said first position or between said first position and said threshold position causes said switch to close said valve or to keep said valve closed and wherein arranging said head with said bottle at said second position or between said second position and said threshold position causes said switch to open said valve or to keep said valve open.

2. The apparatus according to claim 1, wherein said liquid in said bottle can be carbonated if the valve is closed and wherein gas can be released from said bottle through the valve, if said valve is open.

3. The apparatus according to claim 1, wherein said head is pivotably attached to said main body, such that said head with said bottle can be pivoted between said first and said second position.

4. The apparatus according to claim 1, wherein said switch is a lever switch arranged between said main body and said head, wherein arranging said head with said bottle between said first position and said threshold position actuates a lever of said lever switch, causing said lever switch to close said valve or to keep said valve closed, and wherein arranging said head with said bottle between said second position and said threshold position releases said lever, causing said lever switch to open said valve or to keep said valve open.

5. The apparatus according to claim 4, wherein the valve is a normally open valve.

6. The apparatus according to claim 5, wherein said valve is a normally open solenoid valve, wherein actuating said lever enables said normally open solenoid valve to energize, whereby said normally open solenoid valve is closed or kept closed and wherein releasing said lever causes said normally open solenoid valve to deenergize, which causes said normally open solenoid valve to open or to keep said normally open solenoid valve open.

7. The apparatus according to claim 6, wherein said normally open solenoid valve is configured to be energized by actuating the lever only upon a user input.

8. The apparatus according to claim 5, wherein said valve is a normally open solenoid valve, wherein actuating said lever causes said normally open solenoid valve to energize, which causes said normally open solenoid valve to close or to keep said normally open solenoid valve closed and wherein releasing said lever causes said normally open solenoid valve to deenergize, which causes said normally open solenoid valve to open or to keep said normally open solenoid valve open.

9. The apparatus according to claim 3, wherein said first position and said threshold position are separated by a pivot angle β of 2° to 15°.

10. The apparatus according to claim 1, wherein said switch is an optical or gyroscopic switch configured to detect a position of said head with said bottle, and wherein if said optical or gyroscopic switch detects a position of said head with said bottle corresponding to a position at said first position or between said first and said threshold position, said switch causes said valve to close or to keep said valve closed and wherein if said optical or gyroscopic switch detects a position of said head with said bottle corresponding to a position between said second and said threshold position or at said second position, said optical or gyroscopic switch causes said valve to open or to keep said valve open.

11. The apparatus according to claim 1, further comprising a water tank configured to be filled with water, wherein said water tank is in fluidic connection with said bottle via a liquid line.

12. The apparatus according to claim 11, further comprising a pump for pumping water from said water tank into said bottle.

13. The apparatus according to claim 1, wherein said valve is further configured to open if a gas pressure inside said bottle exceeds a predetermined value.

14. The apparatus according to claim 1, further comprising a pressure relief valve in fluidic connection with said bottle via a pressure relief line, wherein said pressure relief valve is configured to open if a gas pressure inside said bottle exceeds a predetermined value, wherein gas is released from said bottle.

15. The apparatus according to claim 1, further comprising said bottle.

16. The apparatus according to claim 15, wherein an opening portion of said bottle forms a male counterpart complementary to a female receptor portion of said head, such that said bottle and said head are configured and arranged to be connected to each other via a bayonet mount formed by said female receptor portion of said head and said opening portion of said bottle.

17. The apparatus according to claim 1, comprising a pressurizing line for carbonating said liquid in said bottle, a normally closed valve arranged along said pressurizing line, a trigger mechanism operatively connected to said normally closed valve, as well as a gas source fluidly connected to said pressurizing line, wherein actuating said trigger mechanism causes said normally closed valve to open, creating a fluid connection between said gas source and said bottle, wherein a predetermined amount of gas is injected from said gas source to said bottle.

18. The apparatus according to claim 1, comprising a mechanism configured to open said valve upon carbonation of said liquid in said bottle after a predetermined lull time, such that gas can be released from said bottle through said valve.

19. The apparatus according to claim 18, wherein said mechanism is configured to release said gas in a sequence of subsequent opening and closing events of said valve.

20. The apparatus according to claim 1, comprising a control unit with a safety shutdown function configured such that upon a failure event, said safety shutdown function stops fluid transfer into the bottle and causes said valve to open and said normally closed.
